(19) United States
(12) Patent Application Publication
(10) Pub. No.: US 2021/0260852 A1
(43) Pub. Date: Aug. 26, 2021

(54) LAMINATE WITH A GLASS LAYER AND IMAGE DISPLAY APPARATUS INCLUDING THE LAMINATE WITH A GLASS LAYER

(71) Applicant: NITTO DENKO CORPORATION, Ibaraki-shi, Osaka (JP)

(72) Inventors: Hong Chan Cho, Pyeongtaek-City (KR); Takehito Fuchida, Ibaraki-shi (JP)

(73) Assignee: NITTO DENKO CORPORATION, Ibaraki-shi, Osaka (JP)

(21) Appl. No.: 17/274,507

(22) PCT Filed: Mar. 12, 2020
(86) PCT No.: PCT/JP2020/010769

§ 371 Date: Mar. 9, 2021

(30) Foreign Application Priority Data
Aug. 20, 2019 (JP) 2019-150559

(51) Int. Cl. B32B 17/10; G02B 1/14; G09F 9/30; C09J 7/38

(52) U.S. Cl. CPC B32B 17/10743; G02B 1/14; G09F 9/301; B32B 17/10733; B32B 2307/536; C09J 7/38; B32B 2375/00; B32B 2363/00; B32B 2457/20; B32B 17/1077

(57) ABSTRACT

Provided is a laminate with a glass layer having excellent surface hardness and impact resistance. A laminate with a glass layer of the present invention includes a glass layer, a first pressure-sensitive adhesive layer, an impact absorbing layer, and a second pressure-sensitive adhesive layer in the stated order. The laminate with a glass layer has a pencil hardness of 5 H or more, and according to the laminate with a glass layer, an impact amount S_{A} detected when a stainless-steel ball having a weight of 10 g and a diameter of 13 mm is vertically dropped from a height of 40 cm onto a surface of an impact detection sensor and an impact amount S_{B} detected when the stainless-steel ball is vertically dropped from a height of 40 cm onto the laminate with a glass layer placed on the surface of the impact detection sensor satisfy the following relationship: {(S_{A}−S_{B})/S_{A}}×100≥25(%).

### TECHNICAL FIELD

The present invention relates to a laminate with a glass layer and an image display apparatus including the laminate with a glass layer.

### BACKGROUND ART

A surface member to be used in an image display apparatus is required to have both excellent surface hardness and excellent impact resistance. However, there is a trade-off relationship between the surface hardness and the impact resistance, and hence there is still room for consideration in order to achieve these properties at a sufficiently satisfactory level. Such requirement is made in, for example, a curved image display apparatus and/or a bendable or foldable image display apparatus, as well as a general image display apparatus.

### CITATION LIST

### Patent Literature

[PTL 1] JP 2019-025901 A

### SUMMARY OF INVENTION

### Technical Problem

The present invention has been made to solve the above-mentioned problem of the related art, and a primary object of the present invention is to provide a laminate with a glass layer having excellent surface hardness and excellent impact resistance.

### Solution to Problem

According to one embodiment of the present invention, there is provided a laminate with a glass layer, including a glass layer, a first pressure-sensitive adhesive layer, an impact absorbing layer, and a second pressure-sensitive adhesive layer in the stated order. The laminate with a glass layer has a pencil hardness of 5 H or more, and according to the laminate with a glass layer, an impact amount S_{A} detected when a stainless-steel ball having a weight of 10 g and a diameter of 13 mm is vertically dropped from a height of 40 cm onto a surface of an impact detection sensor and an impact amount S_{B} detected when the stainless-steel ball is vertically dropped from a height of 40 cm onto the laminate with a glass layer placed on the surface of the impact detection sensor satisfy the following relationship: {(S_{A}−S_{B})/S_{}*100≥25}(%)

In one embodiment, the glass layer has a thickness of 100 μm or less, the first pressure-sensitive adhesive layer has a thickness of 25 μm or less, the impact absorbing layer has a thickness of from 30 μm to 200 μm, and the second pressure-sensitive adhesive layer has a thickness of 60 μm or less, and the impact absorbing layer has a modulus of elasticity of 0.1 GPa or less.

In one embodiment, the impact absorbing layer is a resin layer containing at least one selected from the group consisting of an epoxy-based resin, a urethane-based resin, and an acrylic resin.

In one embodiment, the laminate with a glass layer further includes an optical film on a side of the second pressure-sensitive adhesive layer opposite to the impact absorbing layer.

According to another embodiment of the present invention, there is provided an image display apparatus. The image display apparatus includes a display cell and the above-mentioned laminate with a glass layer arranged on a viewer side of the display cell.

In one embodiment, the image display apparatus is bendable or foldable.

### Advantageous Effects of Invention

According to the embodiments of the present invention, a desired impact absorption rate can be achieved by forming the first pressure-sensitive adhesive layer, the impact absorbing layer, and the second pressure-sensitive adhesive layer in the stated order in the laminate with a glass layer. As a result, the laminate with a glass layer having excellent surface hardness and excellent impact resistance can be achieved.

### BRIEF DESCRIPTION OF DRAWINGS

FIG. 1 is a schematic sectional view for illustrating a laminate with a glass layer according to one embodiment of the present invention.

FIG. 2 is a schematic sectional view for illustrating a laminate with a glass layer according to another embodiment of the present invention.

### DESCRIPTION OF EMBODIMENTS

A. Overview of Laminate with Glass Layer

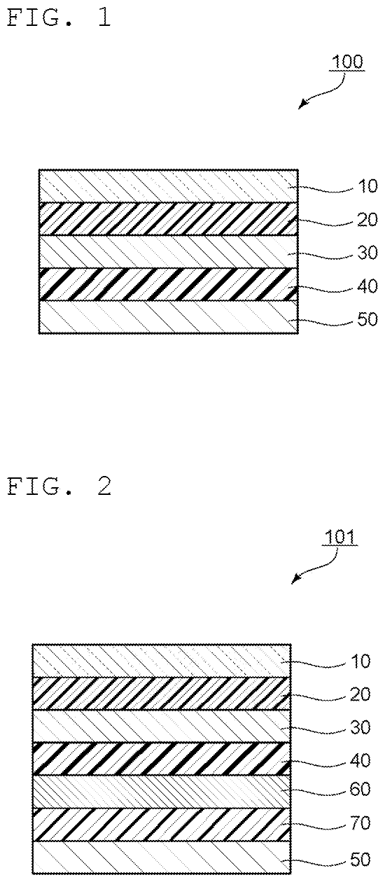

FIG. 1 is a schematic sectional view for illustrating a laminate with a glass layer according to one embodiment of the present invention. A laminate 100 with a glass layer of the illustrated example includes a glass layer 10, a first pressure-sensitive adhesive layer 20 formed on one surface of the glass layer 10, an impact absorbing layer 30 bonded to the glass layer 10 via the first pressure-sensitive adhesive layer 20, and a second pressure-sensitive adhesive layer 40 formed on a side of the impact absorbing layer 30 opposite to the first pressure-sensitive adhesive layer 20. Specifically, the laminate 100 with a glass layer of the illustrated example includes the glass layer 10, the first pressure-sensitive adhesive layer 20, the impact absorbing layer 30, and the second pressure-sensitive adhesive layer 40 in the stated order. In practical use, a separator 50 is temporarily bonded to a surface of the second pressure-sensitive adhesive layer 40 on a side opposite to the impact absorbing layer 30 so as to be peelable. When the separator 50 is temporarily bonded, the second pressure-sensitive adhesive layer can be protected until the laminate with a glass layer is put into use, and the laminate with a glass layer can be formed into a roll.

The laminate with a glass layer has a pencil hardness of 5 H or more, preferably 6 H or more, more preferably 7 H or more, still more preferably 8 H or more. According to the embodiment of the present invention, a laminate with a glass layer having both such significantly high surface hardness and excellent impact resistance can be achieved.

According to the laminate with a glass layer, an impact amount S_{A} detected when a stainless-steel ball having a weight of 10 g and a diameter of 13 mm is vertically dropped from a height of 40 cm onto a surface of an impact detection sensor and an impact amount S3 detected when the stainless-steel ball is vertically dropped from a height of 40 cm onto the laminate with a glass layer placed on the surface of the impact detection sensor satisfy the following relationship (the relationship is hereinafter sometimes referred to as “impact absorption rate”).

{(S_{A}−S_{B})/S_{A}}×100≥25(%)

The impact absorption rate is preferably 30% or more, more preferably 35% or more, still more preferably 40% or more. The upper limit of the impact absorption rate may be, for example, 60%. The impact detection sensor may be, for example, an impact detection sensor provided in a pressurization measuring device. As the pressurization measuring device, there is given, for example, “480C02” (product name) manufactured by PCB Piezotronics.

The laminate 100 with a glass layer may be bonded to any appropriate member (e.g., a resin film) via the second pressure-sensitive adhesive layer 40 and used as a cover member. In one embodiment, the laminate 100 with a glass layer may be bonded to an image display panel to be used as a viewer-side cover member of an image display apparatus. Herein, the image display panel includes an image display cell and any appropriate optical film bonded to the image display cell in accordance with the purposes.

FIG. 2 is a schematic sectional view for illustrating a laminate with a glass layer according to another embodiment of the present invention. A laminate 101 with a glass layer of the illustrated example further includes an optical film 60 bonded to the impact absorbing layer 30 via the second pressure-sensitive adhesive layer 40. As the optical film 60, there is given any appropriate film or member that may be used in an image display apparatus. Examples of the optical film include a polarizing plate, a circularly polarizing plate, a retardation film, a conductive film for a touch panel, a polarizing plate with a surface treatment layer, a circularly polarizing plate with a surface treatment layer, and a retardation film with a surface treatment layer. Examples of the surface treatment layer include a hard coat layer, an antireflection layer, a sticking preventing layer, an antiglare layer, an ultrahigh retardation layer, and a λ/4 plate. The laminate 101 with a glass layer of the illustrated example typically includes a third pressure-sensitive adhesive layer 70 formed on a side of the optical film 60 opposite to the second pressure-sensitive adhesive layer 40. In practical use, as in the embodiment of FIG. 1, the separator 50 is temporarily bonded to a surface of the third pressure-sensitive adhesive layer 70 on a side opposite to the optical film 60 so as to be peelable. The laminate 101 with a glass layer may be bonded to an image display panel or an image display cell, depending on the type of the optical film included therein, to be used as a viewer-side cover member of an image display apparatus.

The laminate with a glass layer may have a sheet shape or an elongated shape. As used herein, the term “elongated shape” means a long and thin shape having a length sufficiently large with respect to a width, and encompasses, for example, a long and thin shape having a length that is 10 times or more, preferably 20 times or more as large as the width. The laminate with a glass layer having an elongated shape may be typically wound in a roll shape.

Now, the glass layer, the first pressure-sensitive adhesive layer, the impact absorbing layer, and the second pressure-sensitive adhesive layer are described. The optical film is as described above, and any appropriate pressure-sensitive adhesive may be used for the third pressure-sensitive adhesive layer. Accordingly, description thereof is omitted.

B. Glass Layer

As glass for forming the glass layer, any appropriate glass (glass film) may be adopted as long as a laminate with a glass layer having excellent surface hardness and excellent impact resistance can be achieved. As the glass, there are given, for example, soda-lime glass, borate glass, aluminosilicate glass, and quartz glass according to the classification based on a composition. In addition, there are given alkali-free glass and low-alkali glass according to the classification based on an alkaline component. The content of an alkali metal component (e.g., Na₂O, K₂0, or Li₂O) in the glass is preferably 15 wt % or less, more preferably 10 wt % or less.

The glass layer has a thickness of preferably 100 μm or less, more preferably from 30 μm to 100 μm. When the thickness of the glass layer falls within such ranges, a laminate with a glass layer having excellent surface hardness and excellent impact resistance can be achieved due to the synergistic effect with the effect of the thicknesses of the first pressure-sensitive adhesive layer, the second pressure-sensitive adhesive layer, and the impact absorbing layer.

The glass layer has a light transmittance at a wavelength of 550 nm of preferably 85% or more. The glass layer has a refractive index at a wavelength of 550 nm of preferably from 1.4 to 1.65.

The glass has a density of preferably from 2.3 g/cm³ to 3.0 g/cm³, more preferably from 2.3 g/cm³ to 2.7 g/cm³. When the density of the glass falls within such ranges, the laminate with a glass layer can be reduced in weight.

As the glass (glass film) for forming the glass layer, a commercially available product may be used as it is, or a commercially available glass film may be abraded to a desired thickness to be used. Specific examples of the commercially available product include “Willow Glass”, “7059”, “1737”, or “EAGLE2000” manufactured by Corning Inc., “AN100” manufactured by AGC Inc., “NA-35” manufactured by NH Techno Glass Corporation, “G-Leaf (trademark)” or “OA-10” manufactured by Nippon Electric Glass Co., Ltd., and “D263” or “AF45” manufactured by Schott AG.

C. First Pressure-sensitive Adhesive Layer

The first pressure-sensitive adhesive layer 20 may be typically formed of an acrylic pressure-sensitive adhesive (acrylic pressure-sensitive adhesive composition). The acrylic pressure-sensitive adhesive composition typically contains a (meth)acrylic polymer as a main component. The (meth)acrylic polymer may be contained in the pressure-sensitive adhesive composition in a proportion of, for example, 50 wt % or more, preferably 70 wt % or more, more preferably 90 wt % or more in a solid content of the pressure-sensitive adhesive composition. The (meth)acrylic polymer contains, as a monomer unit, an alkyl (meth)acrylate as a main component. The (meth)acrylate refers to an acrylate and/or a methacrylate. As an alkyl group of the alkyl (meth)acrylate, there is given, for example, a linear or branched alkyl group having 1 to 16 carbon atoms. The average number of carbon atoms of the alkyl group is preferably from 3 to 9, more preferably from 3 to 6. As a monomer for forming the (meth)acrylic polymer, there are given, in addition to the alkyl (meth)acrylate, a carboxyl group-containing monomer (e.g., (meth)acrylic acid), a hydroxyl group-containing monomer (e.g., hydroxyethyl acrylate), an amide group-containing monomer (e.g., acrylamide), an aromatic ring-containing (meth)acrylate (e.g., benzyl acrylate), a heterocycle-containing (meth)acrylate (e.g., acryloylmorpholine), and a (meth)acrylate having a bridged ring structure (e.g., dicyclopentanyl (meth)acrylate). The acrylic pressure-sensitive adhesive composition may preferably contain a silane coupling agent and/or a cross-linking agent. As the silane coupling agent, there is given, for example, an epoxy group-containing silane coupling agent. As the cross-linking agent, there are given, for example, an isocyanate-based cross-linking agent and a peroxide-based cross-linking agent. Through use of an appropriate combination of the monomer unit of the (meth)acrylic polymer, the silane coupling agent, and the cross-linking agent, an acrylic pressure-sensitive adhesive (as a result, the first pressure-sensitive adhesive layer) having desired characteristics can be obtained. The detail of the first pressure-sensitive adhesive layer or the acrylic pressure-sensitive adhesive composition is described in, for example, JP 2007-133147 A, JP 2016-190996 A, and JP 2018-028573 A, the descriptions of which are incorporated herein by reference.

The first pressure-sensitive adhesive layer has a thickness of preferably 25 μm or less, more preferably 20 μm or less, still more preferably 10 μm or less. The lower limit of the thickness of the first pressure-sensitive adhesive layer may be, for example, 2 μm. When the thickness of the first pressure-sensitive adhesive layer falls within such ranges, a laminate with a glass layer having excellent surface hardness and excellent impact resistance can be achieved due to the synergistic effect with the effect of the thicknesses of the glass layer, the second pressure-sensitive adhesive layer, and the impact absorbing layer.

The first pressure-sensitive adhesive layer has a storage modulus of elasticity G₁′ at 25° C. of preferably 50 Pa or more. When the storage modulus of elasticity of the first pressure-sensitive adhesive layer falls within such range, the synergistic effect with the above-mentioned effect of the thicknesses can be exhibited.

D. Impact Absorbing Layer

The impact absorbing layer 30 may be formed of any appropriate resin layer capable of achieving the above-mentioned desired impact absorption rate. The resin layer may be made of a resin film or a pressure-sensitive adhesive. The impact absorbing layer typically contains an epoxy-based resin, a urethane-based resin, or an acrylic resin. Those resins may be used alone or in combination thereof.

The impact absorbing layer has a thickness of preferably from 30 μm to 200 μm, more preferably from 30 μm to 150 μm, still more preferably from 40 μm to 120 μm. When the thickness of the impact absorbing layer falls within such ranges, a laminate with a glass layer having excellent surface hardness and excellent impact resistance can be achieved due to the synergistic effect with the effect of the thicknesses of the glass layer, the first pressure-sensitive adhesive layer, and the second pressure-sensitive adhesive layer.

The impact absorbing layer has a storage modulus of elasticity Gₛ′ at 25° C. of preferably 0.1 GPa or less, more preferably from 0.01 MPa to 0.1 GPa. When the storage modulus of elasticity of the impact absorbing layer falls within such ranges, the impact absorbing layer has an advantage of absorbing impact to the glass, to thereby prevent cracking of the glass. Further, the synergistic effect with the above-mentioned effect of the thicknesses can also be exhibited.

E. Second Pressure-Sensitive Adhesive Layer

The second pressure-sensitive adhesive layer 40 may be typically formed of an acrylic pressure-sensitive adhesive (acrylic pressure-sensitive adhesive composition) as with the first pressure-sensitive adhesive layer. The acrylic pressure-sensitive adhesive for forming the second pressure-sensitive adhesive layer may be the same as or different from the acrylic pressure-sensitive adhesive for forming the first pressure-sensitive adhesive layer. The acrylic pressure-sensitive adhesive is as described in the section C with respect to the first pressure-sensitive adhesive layer.

The second pressure-sensitive adhesive layer has a thickness of preferably 60 μm or less, more preferably 35 μm or less, still more preferably 20 μm or less. The lower limit of the thickness of the second pressure-sensitive adhesive layer may be, for example, 2 μm. When the thickness of the second pressure-sensitive adhesive layer falls within such ranges, a laminate with a glass layer having excellent surface hardness and excellent impact resistance can be achieved due to the synergistic effect with the effect of the thicknesses of the glass layer, the first pressure-sensitive adhesive layer, and the impact absorbing layer.

The thickness of the impact absorbing layer is larger than the thickness of the first pressure-sensitive adhesive layer or the thickness of the second pressure-sensitive adhesive layer in one embodiment, and is larger than the thickness of the first pressure-sensitive adhesive layer and the thickness of the second pressure-sensitive adhesive layer in one embodiment. When the thickness of the impact absorbing layer, the thickness of the first pressure-sensitive adhesive layer, and the thickness of the second pressure-sensitive adhesive layer have such relationship, both more excellent impact resistance and more excellent surface hardness can be achieved.

The second pressure-sensitive adhesive layer has a storage modulus of elasticity G₂′ at 25° C. of preferably 20 Pa or more. When the storage modulus of elasticity of the second pressure-sensitive adhesive layer falls within such range, the synergistic effect with the above-mentioned effect of the thicknesses can be exhibited.

The storage modulus of elasticity Gₛ′ of the impact absorbing layer, and the storage modulus of elasticity G₁′ of the first pressure-sensitive adhesive layer or the storage modulus of elasticity G₂′ of the second pressure-sensitive adhesive layer have a relationship of Gₛ′≤G₁′ or Gₛ′≤G₂′ in one embodiment. When G₂′ and G₁′ or G₂′ have such relationship, both more excellent impact resistance and more excellent surface hardness can be achieved.

F. Image Display Apparatus

The laminate with a glass layer according to the embodiment of the present invention (e.g., the laminates with a glass layer described in the sections A to E) can be suitably applied to an image display apparatus as described above. Thus, the image display apparatus is also encompassed in the embodiment of the present invention. The image display apparatus includes a display cell and the laminate with a glass layer according to the embodiment of the present invention arranged on a viewer side of the display cell. The laminate with a glass layer is arranged so that the glass layer is placed on a viewer side. Examples of the image display apparatus include a liquid crystal display apparatus, an organic electroluminescence (EL) display apparatus, and a quantum dot display apparatus. In one embodiment, the image display apparatus has a curved shape (substantially a curved display screen) and/or is bendable or foldable.

### EXAMPLES

The present invention is specifically described below by way of Examples, but the present invention is not limited to these Examples. Evaluation items in Examples are as described below.

(1) Impact Absorption Rate

First, a stainless-steel ball having a weight of 10 g and a diameter of 13 mm was vertically dropped from a height of 40 cm onto a stainless-steel plate installed on a sensor (product name: 480C02) manufactured by PCB Piezotronics, and an impact amount S_{A} was measured with HiCORDER (product name: MR8870) manufactured by Hioki E.E. Corporation, which was connected to a sensor. Next, each of the laminates with a glass layer obtained in Examples and Comparative Examples was placed on the surface of the stainless-steel plate on the sensor. The stainless-steel ball was vertically dropped from a height of 40 cm onto the laminate with a glass layer, and an impact amount S_{B} was measured in the same manner. The impact absorption rate was determined through use of S_{A}, S_{B} and the following expression.

Impact absorption rate (%)={(S_{A}−S_{B})/S_{A}}*100

### (2) Pencil Hardness

Each of the laminates with a glass layer obtained in Examples and Comparative Examples was measured in conformity with JIS K5600 “Scratch hardness (Pencil method)”.

### Production Example 1

### Formation of Pressure-Sensitive Adhesive Layer

92 Parts by weight of butyl acrylate, 5 parts by weight of N-acryloylmorpholine (ACMO), 2.9 parts by weight of acrylic acid, 0.1 part by weight of 2-hydroxyethyl acrylate, 0.1 part by weight of 2,2-azobisisobutyronitrile serving as a polymerization initiator, and 200 parts by weight of ethyl acetate were loaded into a four-necked flask equipped with a stirring blade, a thermometer, a nitrogen gas introduction tube, and a condenser. While the contents were gently stirred, a nitrogen gas was introduced into the flask to purge the inside thereof with nitrogen. After that, the liquid temperature in the flask was maintained around 55° C., and the polymerization reaction was performed for 8 hours to prepare an acrylic polymer solution. The weight average molecular weight of the acrylic polymer was 1,780,000. 0.15 Part by weight of dibenzoyl peroxide (one-minute half-life: 130° C.) serving as a cross-linking agent, and 0.6 part by weight of a polyisocyanate-based cross-linking agent (Coronate L, manufactured by Nippon Polyurethane Industry Co., Ltd.) made of a trimethylolpropane adduct of tolylene diisocyanate were blended with 100 parts by weight of a solid content of the obtained acrylic polymer solution, to thereby prepare an acrylic pressure-sensitive adhesive solution. Next, the obtained acrylic pressure-sensitive adhesive solution was applied to one surface of a polyethylene terephthalate (PET) film (manufactured by Mitsubishi Chemical Polyester Film Co., Ltd,, thickness: 38 μm) subjected to silicone treatment, and dried and cross-linked at 150° C. for 3 minutes, to thereby form a pressure-sensitive adhesive layer A having a thickness of 5 μm after the drying.

### Production Example 2

### Formation of Pressure-Sensitive Adhesive Layer

99 parts by weight of butyl acrylate, 1 part by weight of 4-hydroxybutyl acrylate, 0.1 part by weight of 2,2-azobisisobutyronitrile serving as a polymerization initiator, and 200 parts by weight of ethyl acetate were loaded into a four-necked flask equipped with a stirring blade, a thermometer, a nitrogen gas introduction tube, and a condenser. While the contents were gently stirred, a nitrogen gas was introduced into the flask to purge the inside thereof with nitrogen. After that, the liquid temperature in the flask was maintained around 55° C., and the polymerization reaction was performed for 7 hours. Ethyl acetate was added to the obtained reaction liquid to adjust the solid content concentration thereof to 30%. Thus, an acrylic polymer solution was prepared. The weight average molecular weight of the acrylic polymer was 1,600,000. 0.1 Part by weight of an isocyanate-based cross-linking agent (product name: Takenate D110N, trimethylolpropane xylylene diisocyanate, manufactured by Mitsui Chemicals, Inc.), 0.3 part by weight of benzoyl peroxide (product name: Nyper BMT, manufactured by NOF Corporation) serving as a peroxide-based cross-linking agent, and 0.08 part by weight of a silane coupling agent (product name: KBM403, manufactured by Shin-Etsu Chemical Co., Ltd.) were blended with 100 parts by weight of a solid content of the obtained acrylic polymer solution, to thereby prepare an acrylic pressure-sensitive adhesive solution. Next, the obtained acrylic pressure-sensitive adhesive solution was applied to one surface of a polyethylene terephthalate (PET) film (manufactured by Mitsubishi Chemical Polyester Film Co., Ltd., thickness: 38 μm) subjected to silicone treatment, and dried and cross-linked at 150° C. for 3 minutes, to thereby form a pressure-sensitive adhesive layer B having a thickness of 15 μm after the drying.

### Production Example 3

### Formation of Pressure-Sensitive Adhesive Layer

A pressure-sensitive adhesive layer C was formed in the same manner as in Production Example 2 except that the thickness was set to 23 μm.

### Production Example 4

### Formation of Pressure-Sensitive Adhesive Layer

60 Parts by weight of dicyclopentanyl methacrylate (DCPMA), 40 parts by weight of methyl methacrylate (MMA), 3.5 parts by weight of α-thicglycerol serving as a chain transfer agent, and 100 parts by weight of toluene serving as a polymerization solvent were mixed, and the mixture was stirred at 70° C. for 1 hour under a nitrogen atmosphere. Next, 0.2 part by weight of 2,2*-azobisisobutyronitrile (AIBN) was loaded as a thermal polymerization initiator, and the mixture was subjected to a reaction at 70° C. for 2 hours. Then, the resultant was raised in temperature to 80° C. and subjected to a reaction for 2 hours. After that, the reaction liquid was heated to I30° C. to remove toluene, the chain transfer agent, and an unreacted monomer through drying, to thereby obtain an acrylic oligomer in a solid state. The weight average molecular weight of the oligomer was 5,100, and the glass transition temperature (Tg) thereof was 130° C..

Meanwhile, 43 parts by weight of lauryl acrylate (LA), 44 parts by weight of 2-ethylhexyl acrylate (2EHA), 6 parts by weight of 4-hydroxybutyl acrylate (4HBA), 7 parts by weight of N-vinyl-2-pyrrolidone (NVP), and 0.015 part by weight of “Irgacure 184” manufactured by BASF, serving as a photopolymerization initiator, were blended, and the mixture was polymerized by irradiation with ultraviolet rays, to thereby obtain a prepolymer composition (polymerization rate: about 10%) 0.07 Part by weight of 1,6-hexanediol diacrylate (HDDA), 3 parts by weight of the above-mentioned acrylic oligomer, and 0.3 part by weight of a silane coupling agent (“KBM403”, manufactured by Shin-Etsu Chemical Co., Ltd.) were added, as post-addition components, to 100 parts by weight of the obtained prepolymer composition, and the contents were uniformly mixed to prepare a pressure-sensitive adhesive composition.

Through use of, as a base material (also serving as a heavy release film), a PET film (“Diafoil MRF75”, manufactured by Mitsubishi Chemical Corporation) with a thickness of 75 μm having a silicone-based release layer formed on a surface thereof, the above-mentioned photocurable pressure-sensitive adhesive composition was applied to the base material so as to give a thickness of 15 μm, to thereby form an applied layer. A PET film (“Diafoil MRE75”, manufactured by Mitsubishi Chemical Corporation) with a thickness of 75 μm having one surface subjected to silicone release treatment was bonded, as a cover sheet (also serving as a light release film), to the applied layer. The laminate was photocured by being irradiated with ultraviolet rays from the cover sheet side with a black light whose position was adjusted so that the irradiation intensity on an irradiation surface directly under the lamp was 5 mW/cm², to thereby form a pressure-sensitive adhesive layer D having a thickness of 15 μm.

### Production Example 5

### Formation of Pressure-Sensitive Adhesive Layer

A pressure-sensitive adhesive layer E was formed in the same manner as in Production Example 4 except that the thickness was set to 50 μm.

### Production Example 6

### Formation of Impact Absorbing Layer

79 Parts by weight of lauryl acrylate (LA), 20 parts by weight of 2-ethylhexyl acrylate (2EHA), 1 part by weight of 4-hydroxybutyl acrylate (4HBA), and 0.015 part by weight of “Irgacure 184” manufactured by BASF, serving as a photopolymerization initiator, were blended, and the mixture was polymerized by irradiation with ultraviolet rays, to thereby obtain a prepolymer composition (polymerization rate: about 10%) 0.30 Part by weight of 1,6-hexanediol diacrylate (HDDA) and 0.3 part by weight of a silane coupling agent (“KBM403”, manufactured by Shin-Etsu Chemical Co., Ltd.) were added, as post-addition components, to 100 parts by weight of the obtained prepolymer composition, and the contents were uniformly mixed to prepare a pressure-sensitive adhesive composition. The subsequent procedure was set to be the same as that in Production Example 4, and a pressure-sensitive adhesive layer having a thickness of 100 μm was formed. The pressure-sensitive adhesive layer was defined as an impact absorbing layer I.

### Production Example 7

### Formation of Impact Absorbing Layer

A pressure-sensitive adhesive layer having a thickness of 50 μm was formed in the same manner as in Production Example 6. The pressure-sensitive adhesive layer was defined as an impact absorbing layer II.

### Production Example 8

### Formation of Impact Absorbing Layer

A pressure-sensitive adhesive layer having a thickness of 200 μm was formed in the same manner as in Production Example 6. The pressure-sensitive adhesive layer was defined as an impact absorbing layer III.

### Production Example 9

### Production of Polarizing Plate with Retardation Layer

### 9-1. Production of Polarizer

As a thermoplastic resin base material, an amorphous isophthalic acid-copolymerized polyethylene terephthalate film (thickness: 100 μm) having an elongated shape, a water absorption rate of 0.75%, and a Tg of about 75° C. was used. One surface of the resin base material was subjected to corona treatment.

13 Parts by weight of potassium iodide was added to 100 parts by weight of a PVA-based resin in which polyvinyl alcohol (polymerization degree: 4,200, saponification degree: 99.2 mol %) and acetoacetyl-modified PVA (product name: “Gohsefimer Z410”, manufactured by The Nippon Synthetic Chemical Industry Co., Ltd.) were mixed at a ratio of 9:1, and the resultant was dissolved in water, to thereby prepare a PVA aqueous solution (application liquid).

The above-mentioned PVA aqueous solution was applied to the corona-treated surface of the resin base material and dried at 60° C. to form a PVA-based resin layer having a thickness of 13 μm, to thereby produce a laminate.

The obtained laminate was free-end uniaxially stretched at a ratio of 2.4 times in a longitudinal direction (lengthwise direction) between rolls having different peripheral speeds in an oven at 130° C. (in-air auxiliary stretching treatment).

Then, the laminate was immersed in an insolubilizing bath (boric acid aqueous solution obtained by blending 4 parts by weight of boric acid with 100 parts by weight of water) having a liquid temperature of 40° C. for 30 seconds (insolubilizing treatment).

Then, the laminate was immersed in a dyeing bath (iodine aqueous solution obtained by blending iodine and potassium iodide at a weight ratio of 1:7 with 100 parts by weight of water) having a liquid temperature of 30° C. for 60 seconds while the concentrations thereof were adjusted so that a single layer transmittance (Ts) of a polarizer to be finally obtained reached 43.0% or more (dyeing treatment).

Then, the laminate was immersed in a cross-linking bath (boric acid aqueous solution obtained by blending 3 parts by weight of potassium iodide and 5 parts by weight of boric acid with 100 parts by weight of water) having a liquid temperature of 40° C. for 30 seconds (cross-linking treatment).

After that, while the laminate was immersed in a boric acid aqueous solution (boric acid concentration: 4.0 wt %, potassium iodide: 5.0 wt %) having a liquid temperature of 70° C., uniaxial stretching was performed so that a total stretching ratio reached 5.5 times in a longitudinal direction (lengthwise direction) between the rolls having different peripheral speeds (underwater stretching treatment).

After that, the laminate was immersed in a washing bath (aqueous solution obtained by blending 4 parts by weight of potassium iodide with 100 parts by weight of water) having a liquid temperature of 20° C. (washing treatment).

After that, while the laminate was dried in an oven kept at 90° C., the laminate was brought into contact with a heating roll made of SUS having a surface temperature kept at 75° C. for about 2 seconds (drying shrinkage treatment). The shrinkage rate in a width direction of the laminate by the drying shrinkage treatment was 5.2%.

In this manner, a polarizer having a thickness of 5 μm was formed on the resin base material.

9-2. Production of Polarizing Plate

An acrylic film (surface refractive index: 1.50, 40 μm) serving as a protective layer was bonded to the surface (surface on a side opposite to the resin base material) of the polarizer obtained in the foregoing via a UV-curable adhesive. Specifically, the curable adhesive was applied so as to have a total thickness of 1.0 μm, and the acrylic film was bonded to the surface of the polarizer through use of a roll machine. After that, UV rays were radiated from the protective layer side to cure the adhesive. Next, the resin base material was peeled off to obtain a polarizing plate having a configuration of “protective layer/polarizer”.

9-3. Production of First Liquid Crystal Alignment

Fixed Layer and Second Liquid Crystal Alignment Fixed Layer for Forming Retardation Layer

10 g of a polymerizable liquid crystal (product name: “Pariocolor LC242”, represented by the following formula, manufactured by BASF) exhibiting a nematic liquid crystal phase and 3 g of a photopolymerization initiator (product name: “Irgacure 907”, manufactured by BASF) for the polymerizable liquid crystal compound were dissolved in 40 g of toluene to prepare a liquid crystal composition (application liquid).

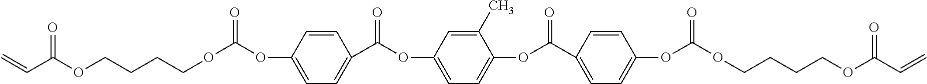 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

The surface of a polyethylene terephthalate (PET) film (thickness: 38 μm) was rubbed through use of a rubbing cloth to be subjected to alignment treatment. The direction of the alignment treatment was set to be 15° when viewed from a viewer side with respect to the direction of an absorption axis of the polarizer when the polarizing plate was bonded. The above-mentioned liquid crystal application liquid was applied to the alignment-treated surface with a bar coater, and the liquid crystal application liquid was dried by heating at 90° C. for 2 minutes, to thereby align the liquid crystal compound. The liquid crystal layer thus formed was irradiated with light of 1 mJ/cm² through use of a metal halide lamp to be cured, to thereby form a liquid crystal alignment fixed layer A on the PET film. The liquid crystal alignment fixed layer A had a thickness of 2.5 μm and an in-plane retardation Re(550) of 270 nm. Further, the liquid crystal alignment fixed layer A had a refractive index profile of nx>ny=nz.

A liquid crystal alignment fixed layer B was formed on the PET film in the manner as in the foregoing except that the application thickness was changed, and the alignment treatment direction was set to be 75° when viewed from a viewer side with respect to the direction of the absorption axis of the polarizer. The liquid crystal alignment fixed layer B had a thickness of 1.5 μm, and an in-plane retardation Re(550) of 140 nm. Further, the liquid crystal alignment fixed layer B had a refractive index profile of nx>ny=nz.

9-4. Production of Polarizing Plate with Retardation Layer

The liquid crystal alignment fixed layer A and the liquid crystal alignment fixed layer B obtained in the section 9-3 were transferred in the stated order onto the surface of the polarizer of the polarizing plate obtained in the section 9-2. In this case, the transfer (bonding) was performed so that an angle formed by the absorption axis of the polarizer and a slow axis of the liquid crystal alignment fixed layer A was 15°, and an angle formed by the absorption axis of the polarizer and a slow axis of the liquid, crystal alignment fixed layer B was 75°. Each transfer (bonding) was performed via the UV-curable adhesive (thickness: 1.0 μm) used in the section 5-2. In this manner, a polarizing plate (circularly polarizing plate) with a retardation layer having a configuration of “protective layer/adhesive layer/polarizer/adhesive layer/retardation layer (first liquid crystal alignment fixed laver/adhesive layer/second liquid crystal alignment fixed layer)” was obtained. The total thickness of the obtained polarizing plate with a retardation layer was 52 μm.

### Production Example 10

### Production of Resin Film

8,000 g of methyl methacrylate (MMA), 2,000 g of methyl 2-(hydroxymethyl) acrylate (MHMA), and 10,000 g of toluene were loaded into a 30 L reaction vessel equipped with a stirrer, a temperature sensor, a condenser tube, and a nitrogen introduction tube. The temperature was raised to 105° c. while nitrogen was allowed to pass through the reaction vessel. When the mixture was refluxed, 10.0 g of tert-amyl peroxyisononanoate (product name: Lupazole 570, manufactured by Atofina Yoshitomi) was added as an initiator. Simultaneously with this, while a solution containing 20.0 g of the initiator and 100 g of toluene was dropped onto the resultant over 4 hours, solution polymerization was performed under reflux (about 105° C. to about 110° C.), and further maturation was performed over 4 hours. To the obtained polymer solution, 10 g of a stearyl phosphate/distearyl phosphate mixture (product name: Phoslex A-18, manufactured by Sakai Chemical Industry, Co., Ltd.), was added, and a cyclization condensation reaction was performed under reflux (about 90° C. to about 110° C.) for 5 hours. Then, the polymer solution obtained by the cyclization condensation reaction was introduced, at a processing speed of 2.0 kg/hour in terms of a resin amount, into a vent-type screw biaxial extruder (ϕ=29.75 mm, L/D=30) having a barrel temperature of 260° C., a rotation number of 100 rpm, a decompression degree of from 13.3 hPa to 400 hPa (10 mmHg to 300 mmHg), one rear vent, and four fore vents, subjected to a cyclization condensation reaction and devolatilization in the extruder, and extruded to obtain a transparent lactone ring-containing acrylic resin pellet. The lactose ring-containing acrylic resin pellet had a lactone cyclization rate of 97.0%, a mass average molecular weight of 147,700, and a Tg (glass transition temperature) of 130° C. The lactone ring-containing acrylic resin obtained in the foregoing was supplied to the extruder, melt-kneaded at 250° C., and was then extruded from a T-die, water-cooled with a cooling roll, and taken up to obtain a film having a thickness of 100 μm. This film was long longitudinally stretched at a ratio of 1.8 times (heating temperature: 140° C.) and then laterally stretched at a ratio of 2.4 times (heating temperature: 140° C.) with a sequential biaxial extruder to obtain a biaxially stretched film having a thickness of 40 μm.

### Example 1

As a glass film for forming a glass layer, “G-Leaf (trademark)” (thickness: 50 μm) manufactured by Nippon Electric Glass Co., Ltd. was used. The pressure sensitive adhesive layer A (first pressure-sensitive adhesive layer) obtained in Production Example 1, the impact absorbing layer I obtained in Production Example 6, and the pressure-sensitive adhesive layer C obtained in. Production Example 3 (second pressure-sensitive adhesive layer) were laminated on the glass film in the stated order to obtain a laminate with a glass layer. The protective layer of the polarizing plate with a retardation layer obtained in Production Example 9 was bonded to the second pressure-sensitive adhesive layer of the laminate with a glass layer to obtain a final laminate with a glass layer. The finally obtained laminate with a glass layer was subjected to the above-mentioned evaluations (1) and (2). The results are shown in Table 1.

### Examples 2 to 9 and Comparative Examples 1 to 5

A laminate with a glass layer was obtained in the same manner as in Example 1 except that the first pressure-sensitive adhesive laver, the second pressure sensitive adhesive layer, the impact absorbing laver, and the optical film or the resin film were used in the combinations shown in Table 1. Each of the finally obtained laminates with a glass layer was subjected to the same evaluations as in Example 1. The results are shown in Table 1. As the resin film, the acrylic resin film produced in Production Example 10 was used.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| First | A | A | B | A | B | A | A | A |
| pressure- | | | | | | | | |
| sensitive | | | | | | | | |
| adhesive | | | | | | | | |
| layer | | | | | | | | |
| Thickness | 5 | 5 | 15 | 5 | 15 | 5 | 5 | 5 |
| (μm) | | | | | | | | |
| Impact | I | I | I | II | II | I | III | I |
| absorbing | | | | | | | | |
| layer | | | | | | | | |
| Thickness | 100 | 100 | 100 | 50 | 50 | 100 | 200 | 100 |
| (μm) | | | | | | | | |
| Second | D | A | D | D | D | D | D | E |
| pressure- | | | | | | | | |
| sensitive | | | | | | | | |
| adhesive | | | | | | | | |
| layer | | | | | | | | |
| Thickness | 15 | 5 | 15 | 15 | 15 | 15 | 15 | 50 |
| (μm) | | | | | | | | |
| Resin film | Circularly | Resin | Resin | Resin | Resin | Resin | Resin | Resin |
| or optical | polarizing | film | film | film | film | film | film | film |
| film | plate | | | | | | | |
| Thickness | 52 | 40 | 40 | 40 | 40 | 40 | 40 | 40 |
| (μm) | | | | | | | | |
| Impact | 37% | 38% | 34% | 31% | 28% | 39% | 39% | 43% |
| absorption | | | | | | | | |
| rate | | | | | | | | |
| Pencil | 7 [symbol] | 9 [symbol] | 9 [symbol] | 9 [symbol] | 9 [symbol] | 7 [symbol] | 6 [symbol] | 6 [symbol] |
| hardness | | | | | | | | |

| | | Compar- | Compar- | Compar- | Compar- | Compar- |
|---|---|---|---|---|---|---|
| | | ative | ative | ative | ative | ative |
| | Example | Example | Example | Example | Example | Example |
| | 9 | 1 | 2 | 3 | 4 | 5 |
| First | C | A | D | E | A | E |
| pressure- | | | | | | |
| sensitive | | | | | | |
| adhesive | | | | | | |
| layer | | | | | | |
| Thickness | 23 | 5 | 15 | 50 | 5 | 50 |
| (μm) | | | | | | |
| Impact | I | — | — | — | Resin | I |
| absorbing | | | | | film | |
| layer | | | | | | |
| Thickness | 100 | | | | 40 | 100 |
| (μm) | | | | | | |
| Second | D | — | — | — | A | E |
| pressure- | | | | | | |
| sensitive | | | | | | |
| adhesive | | | | | | |
| layer | | | | | | |
| Thickness | 15 | | | | 5 | 50 |
| (μm) | | | | | | |
| Resin film | Resin | Circularly | Circularly | Circularly | Resin | Resin |
| or optical | film | polarizing | polarizing | polarizing | film | film |
| film | | plate | plate | plate | | |
| Thickness | 40 | 52 | 52 | 52 | 40 | 40 |
| (μm) | | | | | | |
| Impact | 34% | 6% | 10% | 31% | 8% | 53% |
| absorption | | | | | | |
| rate | | | | | | |
| Pencil | 9 [symbol] | >6 [symbol] | >6 [symbol] | [symbol] | >6 [symbol] | [symbol] |
| hardness | | | | | | |

[symbol]

indicates data missing or illegible when filed

As is apparent from Table 1, through use of a combination of the first pressure-sensitive adhesive layer, the impact absorbing layer, and the second pressure-sensitive adhesive layer, each having a specific configuration, an impact absorption rate of a predetermined value or more can be obtained. As a result, a laminate with a glass layer excellent in both surface hardness (pencil hardness) and impact resistance can be obtained.

### INDUSTRIAL APPLICABILITY

The laminate with a glass layer of the present invention can be suitably used as a cover member for various films or members, or as a viewer-side cover member for an image display apparatus.

### REFERENCE SIGNS LIST

10 glass layer

20 first pressure-sensitive adhesive layer

30 impact absorbing layer

40 second pressure-sensitive adhesive layer

50 separator

60 optical film

70 third pressure-sensitive adhesive layer

100 laminate with glass layer

101 laminate with glass layer

1-6 (canceled)

7. A laminate with a glass layer, comprising a glass layer, a first pressure-sensitive adhesive layer, an impact absorbing layer, and a second pressure-sensitive adhesive layer in the stated order,
wherein the laminate with a glass layer has a pencil hardness of 5 H or more,
wherein the glass layer has a thickness of 100 μm or less, the first pressure-sensitive adhesive layer has a thickness of 25 μm or less, the impact absorbing layer has a thickness of from 30 μm to 200 μm and the second pressure-sensitive adhesive layer has a thickness of 60 μm or less,
wherein the impact absorbing layer has a storage modulus of elasticity G_{S}′ at 25° C. of 0.1 GPa or less,
wherein the storage modulus of elasticity G_{S}′ of the impact absorbing layer and a storage modulus of elasticity G₁′ of the first pressure-sensitive adhesive layer or a storage modulus of elasticity G₂′ of the second pressure-sensitive adhesive layer have a relationship of G_{S}′≤G₁′ or G_{S}′≤G₂′, and
wherein an impact amount S_{A} detected when a stainless-steel ball having a weight of 10 g and a diameter of 13 mm is vertically dropped from a height of 40 cm onto a surface of alt impact detection sensor and an impact amount S_{B} detected when the stainless-steel ball is vertically chopped from a height of 40 cm onto the laminate with a glass layer placed on the sin face of the impact detection sensor satisfy the following relationship:
{(S_{A}−S_{B})/S_{A}}/100≥25(%).

8. The laminate with a glass layer according to claim 7, wherein the impact absorbing layer is a resin layer containing at least one selected from the group consisting of an epoxy-based resin, a urethane-based resin, and an acrylic resin.

9. The laminate with a glass layer according to claim 7, further comprising an optical film on a side of the second pressure-sensitive adhesive layer opposite to the impact absorbing layer.

10. An image display apparatus, comprising a display cell and the laminate with a glass layer of claim 7 arranged on a viewer side of the display cell.

11. The image display apparatus according to claim 10, wherein the image display apparatus is bendable or foldable.
